(19) United States
(12) Patent Application Publication
(10) Pub. No.: US 2025/0058218 A1
(43) Pub. Date: Feb. 20, 2025

(54) STORAGE MEDIUM, INFORMATION PROCESSING APPARATUS, SERVER, AND DISPLAY SYSTEM

(71) Applicant: BANDAI CO., LTD., Tokyo (JP)

(72) Inventors: Yusaku KUBOTA, Tokyo (JP); Tatsuya MORIMOTO, Tokyo (JP); Yushiro UEHARA, Tokyo (JP); Issei HOSODA, Tokyo (JP)

(21) Appl. No.: 18/806,761

(22) Filed: Aug. 16, 2024

(30) Foreign Application Priority Data
Aug. 18, 2023 (JP) 2023-133640

(51) Int. Cl. A63F 13/533; A63F 13/426; A63F 13/5372; A63F 13/795; G06F 3/04845; G06F 3/0489

(52) U.S. Cl. CPC A63F 13/533; A63F 13/426; A63F 13/795; G06F 3/04845; G06F 3/0489; A63F 13/5372

(57) ABSTRACT

A non-transitory computer-readable storage medium storing therein a program that causes a computer to perform processes include: a display control process of displaying a virtual space in which a virtual character associated with a user is positioned; an input process of accepting a movement operation for moving the virtual character, and a control process of controlling a movement of the virtual character in response to the movement operation. The input process includes a first input method and a second input method. The display control process includes performing control so as to: continuously display, together with the virtual space, a first image relating to the first input method regardless of whether the virtual character has moved, and continuously display, after displaying the virtual space, a second image relating to the second input method until the movement operation is accepted, and hide the second image after the movement operation is accepted.

### CROSS-REFERENCE TO RELATED APPLICATION

The present application claims priority under 35 U.S.C. § 119 to Japanese Patent Application No. 2023-133640, filed Aug. 18, 2023, the contents of which are incorporated herein by reference in their entirety.

### BACKGROUND

### Technical Field

The present invention relates to a storage medium, an information processing apparatus, a server, and a display system, and in particular, to a match-making service for a game using a virtual space.

### Description of the Related Art

There is an information interaction method available for a game which is executed on a terminal such as a smartphone or a tablet where a user can perform a touch operation input. With such an information interaction method, for example, the movement of a virtual character is controlled based on a touch operation on a graphical user interface (GUI) (e.g., a virtual joystick) superimposed on a game screen. One example is disclosed in Japanese Unexamined Patent Application Publication No. 2022-522443 (Hereinafter referred to as Patent Document 1).

In recent years, a game play experience has been provided not only by installing a dedicated application to a client terminal in advance and executing the dedicated application, but also by another method. For example, a user can access a specific service site using a browsing application to play a game which is a service on the site. In this case, the use of the service is not limited to a client terminal that allows a touch operation input such as the one described in Patent Document 1, as long as the browsing application can be executed.

When the service is used on a client apparatus that does not allow a touch operation input, there is a possibility that suitable game play cannot be ensured for a user playing a game having a screen configuration such as the one described in Patent Document 1. For example, in order to move a virtual character, the user needs to operate a GUI representing a virtual joystick on the screen using a pointing device or the like. This requires the user to perform a complicated operation input during game play.

It is an object of the present invention to provide a storage medium, an information processing apparatus, a server, and a display system for improving operability during the use of a virtual space.

### BRIEF SUMMARY

In one aspect of the present invention, a non-transitory computer-readable storage medium storing therein a program that causes a computer to perform: a display control process of displaying a virtual space in which a virtual character associated with a user is positioned; an input process of accepting a movement operation for moving the virtual character; and a control process of controlling a movement of the virtual character in response to the movement operation, in which the input process includes a first input method and a second input method as methods for inputting the movement operation, and the display control process includes performing control so as to: continuously display, together with the virtual space, a first image relating to the first input method regardless of whether or not the virtual character has moved; and continuously display, after displaying the virtual space, a second image relating to the second input method until the movement operation is accepted, and hide the second image after the movement operation is accepted.

According to an embodiment of the present invention, it is possible to improve operability during the use of a virtual space.

### BRIEF DESCRIPTION OF THE DRAWINGS

FIG. 1 is a diagram illustrating an example of a configuration of a match-making system according to embodiments and modifications of the present invention;

FIG. 2 is a block diagram illustrating an example of a hardware configuration of a user terminal according to the embodiments and modifications of the present invention;

FIG. 3 is a block diagram illustrating an example of a hardware configuration of a server according to the embodiments and modifications of the present invention;

FIG. 4 is a view illustrating an example of an avatar used in a match-making service according to the embodiments and modifications of the present invention;

FIG. 5 is a view illustrating an example of a battle room of the match-making service according to the embodiments and modifications of the present invention;

FIGS. 6A and 6B are views for describing a match-making function in the battle room according to the embodiments and modifications of the present invention;

FIGS. 7A and 7B are views illustrating an example of a play screen of a battle game according to the embodiments and modifications of the present invention;

FIGS. 8A to 8E are diagrams illustrating an example of a configuration of various pieces of information managed in relation to the match-making service according to the embodiments and modifications of the present invention;

FIG. 9 is a view illustrating an example of the display of avatars in a friend relationship in an entrance room according to the embodiments and modifications of the present invention;

FIGS. 10A and 10B are views illustrating an example of a configuration of a service screen according to the embodiments and modifications of the present invention; and

FIG. 11 is a flowchart illustrating an example of a display control process performed by the user terminal according to the embodiments and modifications of the present invention.

### DETAILED DESCRIPTION

### First Embodiment

Embodiments will be described in detail below with reference to the accompanying drawings. It should be noted that the embodiments described below are not intended to limit the invention set forth in the appended claims. In addition, not all the combinations of features described in the embodiments are essential to the invention. Two or more features of a plurality of the features described in the embodiments may be combined as desired. Further, the same reference numbers are respectively given to the same elements or similar elements and duplicate description therefor will be omitted.

In an embodiment described below, the present invention is applied to a system, in this example, a match-making system. As an example, the match-making system herein provides a service in which a server that accepts connections from information processing apparatuses (user terminals) used by users matches, via a virtual space, two users who are to play a battle game provided by an outside service. However, the present invention is not limited thereto. For example, the present invention is also applicable to a system that is realized by any apparatus that can perform, via a virtual space, match-making for a game in which a plurality of users participate and that can trigger the execution of the game.

In the present specification, “user” indicates a user who uses a service (match-making service) provided by a server 200 in the present match-making system. For convenience of description, a user who has been matched with another user and is playing a game in a virtual space may be occasionally referred to as “player.”

### Configuration of Match-making System

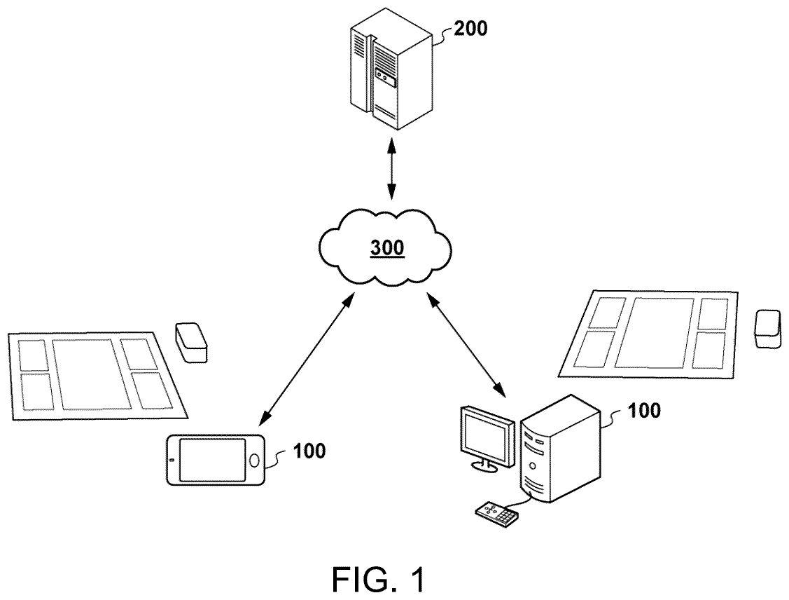

FIG. 1 is a diagram illustrating an example of a configuration of the match-making system according to the present embodiment. In the match-making system, as illustrated in FIG. 1, the server 200 and a plurality of user terminals 100 can be connected to and communicate with each other via a network 300. Further, in the present embodiment, the server 200 provides a match-making service which matches users of the user terminals 100 being connected to the server 200 as players of a battle game and triggers the execution of the battle game. The battle game is provided by the outside service.

In the following description, the outside service refers to a service which assists the execution of the battle game to be played by remote players and which does not have a free match-making type of match-making function in which a predetermined number of players are extracted to be matched with each other before the service is provided. In the present embodiment, when the number of players required for the battle game accesses, using their user terminals 100, a room (connection destination) created by a player who serves as a host, a video chat function using a camera and a microphone of each user terminal 100 becomes available. Then, the outside service realizes game play of a trading card game (TCG) in which the game progresses while the players share the status of each game item placed in an environment (real world) where the players exist. For this purpose, the user terminals 100 may be personal computers (PCs) or smartphones provided with a camera and a microphone.

As described in detail later, the user of the match-making service can use the service by logging in to the service using the user terminal 100 used by the user. When the service becomes available, a virtual space is displayed in which an avatar (operable avatar) corresponding to the user is positioned. The match-making service is a web service which can be connected thereto via a browsing application (hereinafter simply referred to as a browser). The user can log in to the service by completing a user authentication procedure on a specific web page. The user can perform various operation inputs to move an operable avatar positioned in the virtual space, communicate with other users through the avatar (e.g., text chat), and be matched with an opponent for the battle game provided by the outside service.

### Hardware Configuration of User Terminal

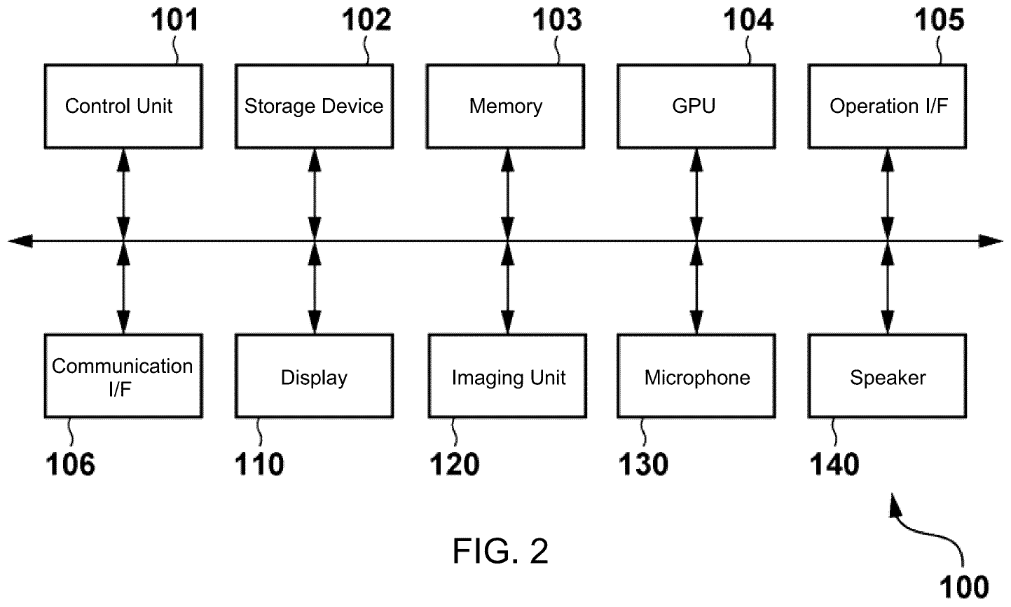

A hardware configuration of the user terminal 100 will be described below with reference to FIG. 2. FIG. 2 is a block diagram illustrating an example of the hardware configuration of the user terminal 100.

A control unit 101 is a processor such as a central processing unit (CPU) and performs various controls including the control of the operation of each hardware included in the user terminal 100. Specifically, the control unit 101 performs control by reading out a necessary program stored in, for example, a storage device 102, deploying the program in a memory 103, and executing the program.

The storage device 102 is a device capable of permanently storing information. Examples of the storage device 102 include a non-volatile memory and a hard disk drive (HDD). The storage device 102 stores an operating system for operating the user terminal 100 and programs relating to various applications. In addition, the storage device 102 stores various data that are used for display relating to a browser and communication functions, in addition to parameter information required for various controls. The memory 103 is a storage device capable of temporarily storing data. Examples of the memory 103 include a volatile memory. The memory 103 may be used not only as an area where each program is deployed but also as a storage area where data output during various hardware operations and various controls are temporarily stored.

A graphics processing unit (GPU) 104 is a drawing device which performs various drawing processes relating to the generation of a display screen for the user terminal 100. The GPU 104 also performs a screen drawing process relating to the virtual space to be presented to the browser while the match-making service is in use. The GPU 104 includes a GPU memory, not illustrated. The GPU 104 deploys various graphics data read out from the storage device 102 and performs predetermined computation to generate various images including a screen. For example, a screen and an image generated by the GPU 104 are displayed on a display 110, which is included in the user terminal 100, so that the user can view the screen and image. The display 110 is a device such as a liquid-crystal display which displays information and is provided with or detachably connected to the user terminal 100. The display 110 displays a screen generated by the GPU 104.

An operation I/F 105 is a user interface which is included in the user terminal 100 and accepts an operation input. When the operation I/F 105 detects that an operation input has been made, the operation I/F 105 outputs a control signal corresponding to the operation input to the control unit 101. In one embodiment, the operation I/F 105 includes, for example, an operation member such as a button and various sensors disposed on the exterior of the user terminal 100. Further, the display 110, which is included in the user terminal 100 according to the present embodiment, detects a touch input, and the operation I/F 105 includes a touch input detection sensor disposed in the display 110.

A communication I/F 106, which is included in the user terminal 100, is a communication interface which enables communication with an external apparatus. The communication I/F 106 may communication with the external apparatus via a wide area network (WAN) such as the Internet or via a local area network (LAN) to exchange information. Although the communication I/F 106 wirelessly performs information communication in the present embodiment, the communication I/F 106 may perform information communication by wire in another embodiment.

An imaging unit 120 is a unit which includes an imaging device including an imaging sensor such as a charge coupled device (CCD) sensor or a complementary metal oxide semiconductor (CMOS) sensor. Although the details will be described later, the imaging unit 120 intermittently captures an image of game cards arranged by the user in an imaging range during the battle game provided by the outside service and outputs the captured image.

A microphone 130 is a sound input interface included in the user terminal 100. In the present embodiment, the battle game provided by the outside service and triggered by the match-making service is described as TCG. Therefore, the microphone 130 obtains the player's voice relating to, for example, declaration or reading out of the effect of a game card. Further, a speaker 140 is a sound output interface included in the user terminal 100. The speaker 140 outputs sound relating to the match-making service and sound relating to the battle game (e.g., the opponent player's declaration and sound effects).

### Hardware Configuration of Server

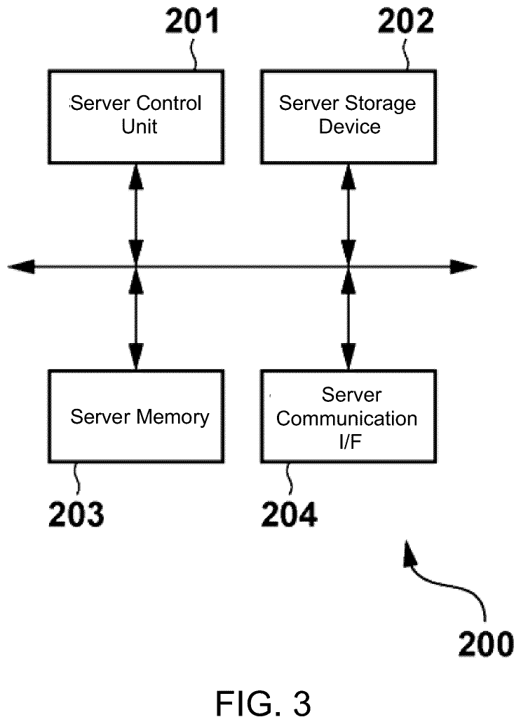

FIG. 3 is a block diagram illustrating an example of a hardware configuration of the server 200 according to the present embodiment. In the following description, any hardware configuration that realizes a similar function to that of the user terminal 100 is prefixed with a term “server” to distinguish the configuration of the server 200 from the configuration of the user terminal 100.

A server control unit 201 is a processor such as a CPU and performs various controls. For example, the server control unit 201 controls the operation of each hardware included in the server 200 and also performs control relating to the realization of various functions including user management and a user match-making function relating to the match-making service. Specifically, the server control unit 201 performs control by reading out a necessary program stored in, for example, a server storage device 202, deploying the program in a server memory 203, and executing the program.

The server storage device 202 is a device capable of permanently storing information. Examples of the server storage device 202 include a non-volatile memory and an HDD. The server storage device 202 stores an operating system for operating the server 200 and programs relating to match-making. In addition, the server storage device 202 stores parameter information required for various controls and also stores various data that are used for providing a match-making function. Further, the server storage device 202 has a database function which manages information regarding each player registered as the user of the match-making system. The server memory 203 is a storage device capable of temporarily storing data. Examples of the server memory 203 include a volatile memory. The server memory 203 may be used not only as an area where each program is deployed but also as a storage area where data output during various hardware operations and various controls are temporarily stored.

A server communication I/F 204, which is included in the server 200, is a communication interface which enables communication with an external apparatus. The server communication I/F 204 may communicate with the external apparatus via a WAN such as the Internet or via a LAN to exchange information. The server communication I/F 204 may perform information communication by wire or wirelessly.

### Overview of Match-Making Service

An overview of the match-making service provided by the match-making system according to the present embodiment will be described below with reference to the drawings.

As described above, when a user activates a browser on the user terminal 100 used by the user, accesses a web page (service site) for the service, and logs in to the service, the user can use the match-making service.

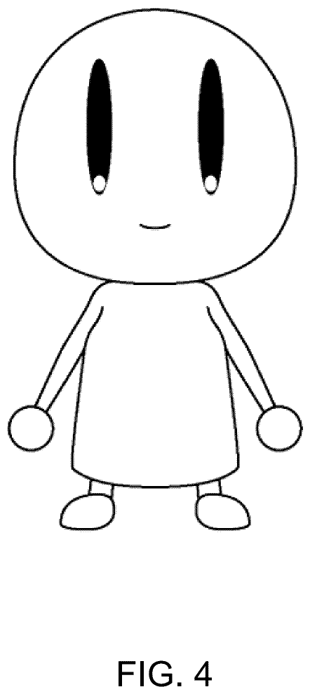

When the user logs in to the service, the virtual space represented by three-dimensional computer graphics is displayed on the user terminal 100 as a service screen. The service screen is an image depicting the virtual space, and the number of pixels of the image is set so as to correspond to, for example, an area of the browser where the web page is displayed. In the virtual space, each user is assigned an avatar (hereafter referred to as an operable avatar) associated with the user. As illustrated in FIG. 4, the avatar is a humanoid three-dimensional model including a head, torso, and legs. Each user can move the operable avatar associated with the user within the virtual space by performing an operation input relating to the movement. In the present embodiment, the virtual space is configured as, for example, a room-like three-dimensional space. In the following description, the virtual space may be occasionally referred to as a “room.” Therefore, the operable avatar moves within the room in response to the user's operation input. The room is configured as a space with a certain size.

In the match-making service according to the present embodiment, multiple types of virtual spaces are provided. Each user can move between the virtual spaces according to the user's needs and receive the service. In other words, the server 200 manages the user's operable avatar such that the user's operable avatar is temporarily positioned in only one virtual space.

The match-making service provides two types of virtual spaces: an entrance room and a battle room. The two types of virtual spaces (rooms) are intended for different uses. Thus, a process that is performed in response to a request from the user as a function of the match-making service differs depending on which virtual space the operable avatar is in. In other words, what function of the match-making service the user can use differs depending on which room the operable avatar is in, the entrance room or the battle room. While the user stays logged in to the service, the operable avatar is controlled so as to be positioned in only one of the rooms and not to be positioned in two or more rooms at a time. In response to the user performing an operation input for transferring the operable avatar from one room to another room while the operable avatar is in one room, the user terminal 100 transmits a corresponding request to the server 200 and the server 200 updates information managed in association with the operable avatar. In this way, the operable avatar is moved (transferred) from one room to another room.

Of the two types of rooms, the battle room is a virtual space which actually provides a user with a function (match-making function) of matching the user with an opponent for the battle game the user wants to play. When match-making is established in the battle room, the execution of the battle game is triggered. By contrast, the entrance room is basically a virtual space which does not provide the user with the function of matching the user with an opponent but provides the user with auxiliary functions such as the setting of the operable avatar and the selection of the battle room to which the operable avatar is transferred. In other words, in the entrance room, match-making is not established and the execution of the battle game is not triggered. The features of each room will be described in more detail below. In the following description, a state in which the operable avatar associated with the user is positioned in a three-dimensional space relating to one of the rooms may be occasionally described as the user's operable avatar “entering” the room.

### Entrance Room

As described above, the entrance room is a virtual space which provides the auxiliary functions for each user to use the battle room. The entrance room is provided for each of the operable avatars and managed in association with, for example, an avatar ID, which uniquely identifies the operable avatar. In other words, the entrance room is a virtual space which is uniquely provided for each operable avatar.

When the user logs in to the service site, the user's operable avatar is first positioned and displayed in the entrance room provided for this operable avatar. By moving the operable avatar in the entrance room, for example, the user can perform an operation input relating to the use of various auxiliary functions.

### Appearance Customization Function

The auxiliary functions available in the entrance room include an appearance customization function which changes the appearance of the operable avatar. For example, it is possible to change the color of the operable avatar and drawing elements constituting the appearance of items attached to, for example, the head and torso of the operable avatar. In the entrance room, the user can change the appearance of the operable avatar by selecting an item to be attached from a list of items owned by the user, for example.

### Transfer Function

The auxiliary functions also include a transfer function which selects a battle room in response to the user's transfer request and transfers the user's operable avatar to the selected battle room.

In the match-making service according to the present embodiment, as described in detail later, the operable avatars of the users who want to be matched with opponents in the same time period are positioned in a battle room, and this state is displayed as the service screen (the screen relating to the match-making service presented to each user via the browser) on the display 110 of the user terminal 100 used by each user. Here, generating the service screen representing the state of the battle room requires information such as the states of other avatars positioned in the same battle room (e.g., whether or not they are being matched, and what their appearances are like). Such information is managed by the server 200 in association with the battle room, and when the user's operable avatar is positioned in the battle room, the information is shared to the user terminal 100 and used to generate the service screen.

Accordingly, the greater the number of avatars positioned in the battle room, the greater the amount of information to be referred to when the service screen is generated. This can increase the computation load on the user terminal 100. Therefore, in the match-making system according to the present embodiment, the maximum number of operable avatars that can be positioned in one battle room (the maximum number of users who can enter the room) is set for each of the battle rooms. Meanwhile, in order to secure the number of users who can use the match-making function at the same time period, two or more battle rooms are provided. As the transfer function, the server control unit 201 performs a process of selecting a battle room based on the user's request from among a plurality of battle rooms provided at the same time period in this way and transferring the operable avatar to the selected battle room.

### Visit Function

Further, the auxiliary functions also include a visit function which allows the user to visit an entrance room provided for an avatar of another user. For example, the user can use the visit function by selecting, from a menu which can be displayed when the operable avatar is in an entrance room, an instruction item relating to the movement of the operable avatar to another entrance room. With the visit function, the operable avatar associated with the user is moved to and displayed in the entrance room provided for the avatar of another user. The entrance room to which the operable avatar is positioned by the visit function may be, for example, determined by the server control unit 201 or determined based on the user's selection of the avatar to visit.

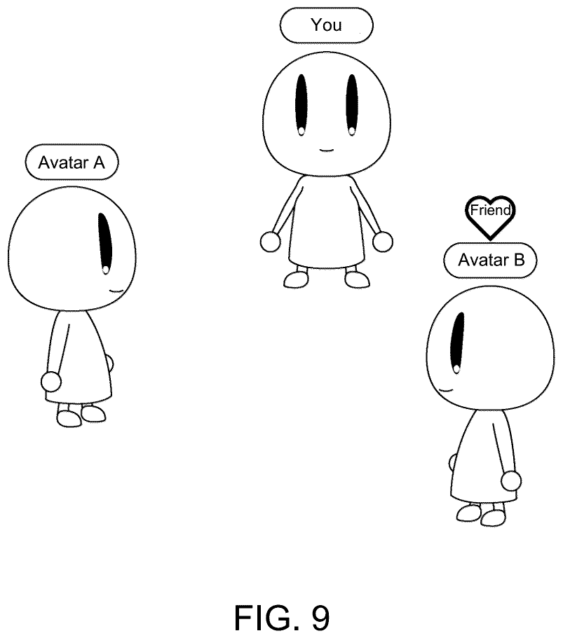

The match-making service provides a friend registration function for operable avatars. On the condition that, for example, a user and an acquaintance or a user with whom the user has played against before have agreed to have a friend relationship, this function sets a friend relationship to avatars associated with these users. Accordingly, for example, the users having a friend relationship between avatars can check their login status or easily visit their entrance rooms. For example, when the user's operable avatar is positioned in its entrance room and an avatar having a friend relationship with the user visits the entrance room, an icon indicating that the avatar is a friend is displayed in the vicinity of the avatar, as illustrated in FIG. 9. Thus, the user can recognize that the user's friend is visiting. A relationship between avatars that is explicitly displayed is not limited to the friend relationship, but can also include, for example, a relationship that the avatars have played against each other in a battle game in the past.

In this way, with the visit function, a user can let other users see the entrance room associated with the user's own operable avatar. Therefore, in the match-making service according to the present embodiment, each entrance room is configured to allow a corresponding user to change the interior and decoration of the room to produce the uniqueness of the user. Each user can decorate the interior of the entrance room by, for example, placing any decorative object obtained by the user.

Further, the interior decoration in the entrance room may include a decorative element which changes in accordance with the state of the operational avatar associated with the entrance room. Such a decorative element may include, for example, an element which changes in accordance with at least one of the number of times a user has played and the number of times the user has won the battle game executed after the user is matched with another user via the operable avatar. Further, in a case where a competition, a play season, or the like is available for the battle game, the decorative element may also include an element such as a trophy or a medal which relates to the play result of the battle game executed after match-making is performed via the operable avatar.

### Battle Room

The battle room is a virtual space in which all of the users can be matched with each other for the battle game in the match-making service. Unlike the entrance room, not only the operable avatar but also the avatars of other users who have entered the same room are positioned in the battle room. The users who have entered the battle room can move their operable avatars within the battle room by performing an operation input relating to the movement. Therefore, in the battle room, each user whose avatar is positioned in the battle room can move the avatar associated with that user and use a function specific to the battle room.

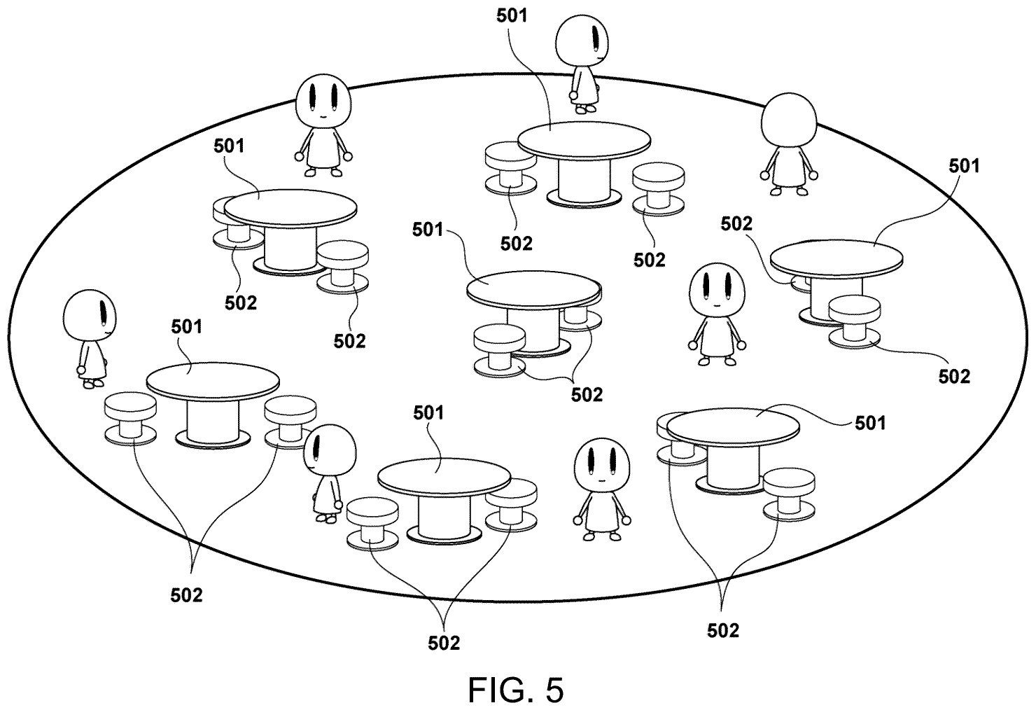

As illustrated in FIG. 5, a plurality of table objects 501 are arranged in the battle room. Further, chair objects 502 are disposed in the vicinity of each table object 501. A user who wants to be matched with another user can use the match-making function by selecting any of the table objects 501. When a match-making request relating to the use of the match-making function is made, the server control unit 201 performs a process relating to the match-making. Further, when match-making is established through the process relating to the match-making, the match-making service triggers the execution of the battle game relating to the outside service in which (two) users who have been matched with each other participate.

### Match-Making Function

The match-making function matches a user with an opponent for the battle game relating to the outside service. In the match-making service according to the present embodiment, a match-making request is accepted in response to an operation of selecting a table object in the battle room. Therefore, an opponent matched with the user is a user whose avatar is positioned in the same battle room.

The server 200 does not forcibly perform match-making to match the user with an opponent, but performs match-making after agreement is reached between the users. Specifically, assume that there is a user who wants another user to request a battle against the user. In this case, the match-making function allows another user who wants a battle against the user to request a battle to the user. When the user accepts the battle request from the other user, the match-making function establishes the match-making to match the user with the other user. The process relating the match-making starts in response to an operation of selecting one table object, and the state of the process is presented to the user through the display with the table object.

When a user who wants to wait for a battle request from another user performs an operation of selecting a table object, confirmation is displayed to confirm that the state of the operable avatar transitions to a match-making standby state. After that, a match-making request for standby (hereinafter occasionally referred to as “standby request”) is transmitted to the server 200. The standby request may include, for example, identification information which uniquely identifies the table object (a combination of a room ID, which uniquely identifies the battle room, and a table ID, which uniquely identifies the selected table object in the battle room) and identification information which uniquely identifies the user (or the user's operable avatar) who has made the standby request. When the server control unit 201 receives the standby request, the server control unit 201 updates the state of the operable avatar of the user to the match-making standby state and transmits the information to the user terminals 100 of the users who have entered the same battle room.

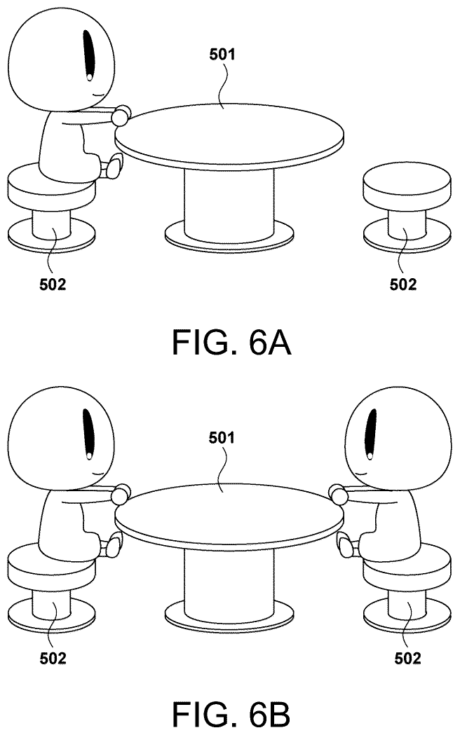

In the match-making standby state, the user's operable avatar is displayed such that the operable avatar is seated on one of the chair objects 502 disposed in the vicinity of the table object 501 on which the selection operation has been performed, as illustrated in FIG. 6A. Since a TCG is generally played on a one-to-one basis, two chair objects are disposed in the vicinity of each table object so as to face each other across the table object in the match-making system according to the present embodiment. The display of the avatar in such a seated state continues until the user performs an operation input relating to the cancellation of the standby or until the battle game executed after the establishment of match-making is completed. In other words, the user's operable avatar in the match-making standby state is displayed without moving from the position of the chair object 502 in the vicinity of the table object 501 in the battle room. In the match-making standby state, even when the user performs an operation input relating to the movement of the operable avatar, the operable avatar is controlled so as not to move.

With one user's avatar seated in the chair object 502 and being in the match-making standby state (such a table object 501 will be hereinafter referred to as “standby table”), other users can make a battle request to the table object 501. In other words, the table object 501 is in a state in which a match-making process relating to the match-making standby state is being performed. In response to the match-making process relating to the match-making standby state being performed, the table object 501 is displayed in a different mode from a previous one (when the process is not performed). For example, the color of the table object 501 is changed. Accordingly, other users can recognize that they can make a battle request to the table object 501.

A user who wants to make a battle request can perform an operation input to the standby table to make a battle request to a user (hereinafter referred to as “standby user”) of an avatar which has arrived the standby table earlier (hereinafter referred to as “standby avatar”). Specifically, for example, when an operation input to the standby table is performed on the user terminal 100 used by the user making the battle request (hereinafter referred to as “requesting user”), the confirmation of making a battle request is displayed and then a match-making request for making the battle request is transmitted to the server 200. The match-making request may include, for example, identification information which uniquely identifies the standby table and identification information which uniquely identifies the requesting user (or the requesting user's operable avatar). When the server control unit 201 receives the match-making request, the server control unit 201 temporarily updates the state of the requesting user's operable avatar (hereafter referred to as “requesting avatar”) to the match-making standby state and shares this information with the user terminals 100 of the users who have entered the same battle room.

When the requesting avatar becomes the match-making standby state, the requesting avatar is displayed such that the requesting avatar is seated in the chair object 502 in the vicinity of the standby table as with the standby avatar, and the requesting avatar and the standby avatar face each other across the table object 501, as illustrated in FIG. 6B. This display continues until the requesting user performs an operation input relating to the cancellation of the battle request, until the standby user performs an operation input relating to the rejection of the battle request, or until the battle game executed after the establishment of match-making is completed. In other words, the requesting avatar in the match-making standby state is displayed without moving from the position of the chair object 502 in the vicinity of the standby table in the battle room. In the match-making standby state, even when the requesting user performs an operation input relating to the movement of the requesting avatar, the requesting avatar is controlled so as not to move.

When the standby avatar and the requesting avatar are seated so as to face each other across the table object 501 in this manner, the server 200 transmits, to the user terminal 100 of the standby user, an inquiry as to whether or not to accept the battle request from the requesting user. The standby user can perform an operation input to accept or reject the battle request made by the requesting user. When the standby user accepts the battle request, the server control unit 201 performs a process of matching the standby user with the requesting user to establish match-making. The server control unit 201 then updates the status information managed for both avatars during the match-making. In other words, the standby user and the requesting user who have been matched become players of the battle game to be subsequently triggered.

In this way, with a table object disposed in a battle room, match-making can be established between users who have entered the same room. That is, in each battle room, the maximum number of match-making that can be performed at the same time period corresponds to the number of table objects arranged in the battle room. Therefore, the server 200 manages information regarding the state of each table object in each battle room. Examples of the state information include whether the match-making process is being performed, whether the execution of the battle game is triggered after the establishment of match-making, and neither of them is performed (neither the match-making process is being performed nor the execution of the battle game is triggered).

When the battle game is triggered after the establishment of match-making, the corresponding table object 501 may be displayed in a further different mode until the triggered battle game is completed. Changing the display mode of the table object 501 in this way allows other users to recognize that match-making has already been established.

In this way, in the match-making service according to the present embodiment, since a series of processes relating to match-making is performed via the table object 501, avatars are controlled so as not to enter the area where the table object 501 is disposed in the battle room. On the other hand, a standby avatar and a requesting avatar are controlled during the series of processes such that they can be positioned in the area where the chair objects 502 are disposed. Therefore, the avatars are controlled such that they can enter the area where the chair objects 502 are disposed. In this case, only the avatars that are actually involved in the match-making process and positioned in the area of the chair objects 502 are controlled to be seated.

### Battle Function

A battle function is a function which executes a battle game in which users who have been matched with each other in a battle room participate. As described above, in the match-making system according to the present embodiment, the battle game is realized using the outside service.

After match-making is performed in the battle room, the server 200 transmits a request to a game server of the outside service, which is not illustrated, to create a connection destination of a battle game, together with information regarding the two players (a standby user and a requesting user) who have been matched. The game server creates a new connection destination of the new battle game in response to the creation request and transmits connection destination information to the server 200. The server 200 then transmits, together with a transfer instruction, the received connection destination information to the user terminal 100 used by each player. At the user terminal 100 which has received the transfer instruction, a connection to the connection destination is triggered on the browser and the display is switched from the match-making service to the outside service. This configuration eliminates the need for each player to directly perform a registration procedure for the outside service and allows each player to start the battle game against the player's opponent who has been matched with the player in the match-making service.

In the present embodiment, the login state in the match-making service is maintained even while the display of the user terminal 100 has transitioned to the outside service (during the execution of the battle game in the outside service) so that each player can easily return to the match-making service after finishing the battle game. In more detail, for example, when the user terminal 100 of each player receives information regarding the connection destination of the outside service, the user terminal 100 opens a different tab (or a different window) of the browser and establishes a connection to the connection destination. Accordingly, the tab for the outside service is displayed as a main tab. That is, the tab for the outside service is selected as a display tab and the display of the browser is switched (the tab for the outside service is displayed instead of a tab displaying the service screen of the match-making service, or a different window is displayed at the front). This triggers temporal transition from the match-making service to the outside service. At this time, the tab for the match-making service is still present even while the outside service is in use. Therefore, each player can check both the state of the battle room in the match-making service and the play screen of the battle game in the outside service.

As described above, the battle game relating to the outside service for which the match-making system according to the present embodiment matches players is a TCG. Simply put, a TCG proceeds as follows. Each player builds a deck using game cards which are real items and obtains a game card that serves as an initial hand from a shuffled deck. Each player adds, on their turn, a game card from the deck to his or her hand and, when necessary, arranges the cards in his or her hand on a play field. A player declares the action of a card placed on the play field and performs various operations relating to the resolution of the declaration. Therefore, it is essential to be able to check the state of the playing field of each player in the progress of the battle game. For this reason, the battle game executed using the outside service proceeds using a video chat function to share, among the players, videos capturing the players' hands and the voices of the declaration made by the players.

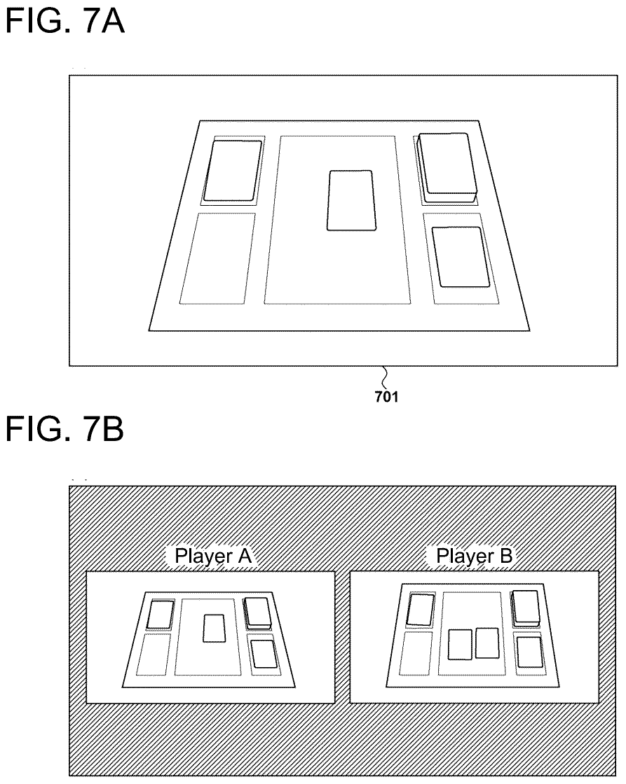

The screen (play screen) displayed on the user terminal 100 used by a player during the game play may, for example, display a live video 701 itself captured by the user terminal 100 used by an opponent of the player, as illustrated in FIG. 7A. In the example of FIG. 7A, the video 701 captured by the user terminal 100 used by the opponent is displayed as it is in full screen. Alternatively, the play screen may display a frame image of the video 701 with a predetermined GUI.

When the battle game relating to the outside service ends, the display of the user terminal 100 used by each player returns from the outside service to the match-making service. The information (end information) indicating that the players have finished using the outside service may be transmitted from the user terminal 100 of at least one of the players to the server 200 or may be transmitted directly from the game server of the outside service to the server 200. The end information also includes information regarding the result (win or loss) of the battle game. To display the result of the battle game played by each player based on the received end information, the server 200 performs control so as to transmit, together with a display request, information for displaying the result of the battle game to the user terminals 100 used by the players. When the user terminal 100 of each player receives the information, the user terminal 100 displays the result of the battle game executed using the outside service.

Further, when the server control unit 201 receives result information regarding the battle game played by the players, the server control unit 201 updates information regarding the battle result managed for the corresponding users and also updates the state of the avatars of the users from a matched state to a non-matched state (free state). The avatar of each user whose state has been changed to the free state is no longer seated in the chair objects in the vicinity of the table object and is displayed as an away state. Then, the avatar can move between the battle rooms again according to an operation input performed by the user terminal 100 used by the user as with the state becoming the match-making standby state.

### Spectator Function

A spectator function allows users other than players to watch a battle game whose execution has been triggered via a battle room. In other words, the match-making service according to the present embodiment provides a function relating to watching of the battle game executed via the battle room as an element of entertainment that can be enjoyed by users who have entered the battle room but are not matched. The spectator function may be realized by using, for example, a publication function provided by the outside service relating to the battle game. The publication function publishes the play screen transmitted and received between the user terminals 100 used by the players who are playing the battle game.

For example, a user can make a spectator request to watch a battle game executed via a table object by performing, on the service screen of the match-making service, an operation input to the table object through which the battle game is being executed. In response to the user making the spectator request to the table object where match-making has been established, the user terminal 100 used by the user making the spectator request switches the display to display the play video of the battle game relating to the table object. In this case, the user's operable avatar may be controlled so as to be displayed to other users such that the user's operable avatar is watching the table object in the vicinity of the table object, for example.

With the spectator function, the display 110 of the user terminal 100 of the user who has made the spectator request may display, for example, a video focusing on cards at one player's hand as illustrated in FIG. 7A or an image including videos of cards at both players' hands during the battle game as illustrated in FIG. 7B.

### Movement Operation Method

In the match-making service according to the present embodiment, there are two types of input methods available as an input operation for moving the operable avatar in the virtual space.

One of the input methods is an input method (first input method) provided assuming that the service is mainly used on the user terminal 100 such as a smartphone or a tablet terminal which includes a touch panel as the operation I/F 105. In this case, the user terminal 100 accepts a movement operation in response to a pointing input being made to an image area of a graphical user interface (GUI) displayed on the service screen. The other input method is an input method (second input method) provided assuming that the service is mainly used on the user terminal 100 such as a PC which includes a keyboard as the operation I/F 105. In this case, the user terminal 100 accepts a movement operation in response to an operation input made to a specific key of the keyboard.

### Display of Input Methods

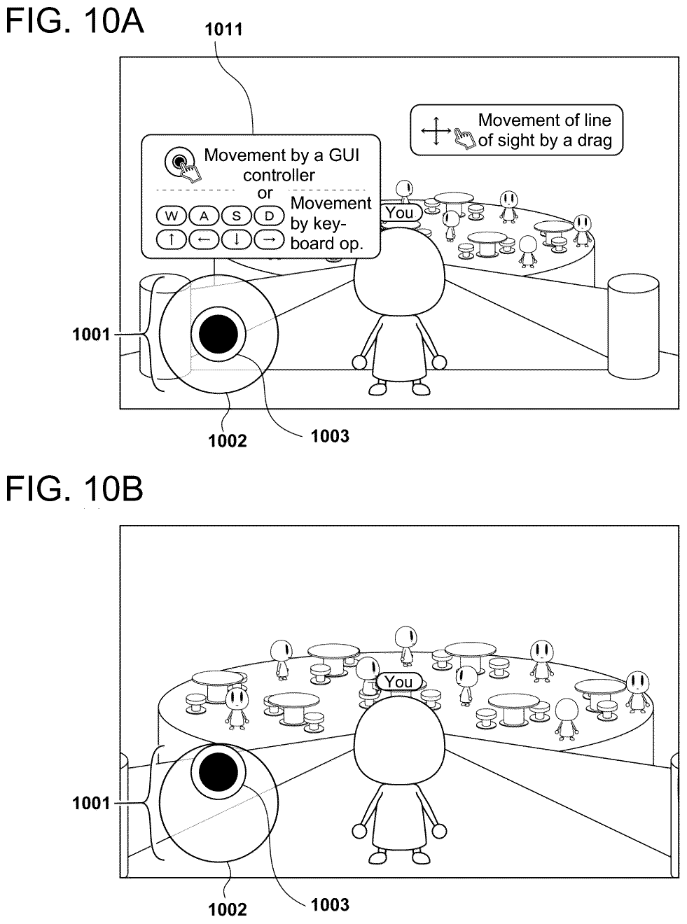

In order to inform the user that these input methods are available as the operations for moving the operable avatar, the service screen includes images relating to these input methods. FIG. 10A illustrates an example of the service screen displayed on the display 110 when the operable avatar is positioned in the battle room. As illustrated in FIG. 10A, the service screen includes a GUI image 1001 relating to the first input method and an explanatory image 1011 relating to the second input method as images relating to the input methods.

The GUI image 1001 includes two types of circular images (a first circular image 1002 and a second circular image 1003) in a superimposed manner in the present embodiment. The first circular image 1002 is displayed at a fixed position on the service screen, while the second circular image 1003 is movably displayed within an area of the first circular image 1002. When the user performs a pointing input to the area of the GUI image 1001, the second circular image 1003 is adjusted and displayed such that its center coordinates become the coordinates specified by the pointing input.

In the first input method, the position of the second circular image 1003 within the first circular image 1002 is converted into a movement operation and then detected. When no pointing input is performed to the area of the GUI image 1001, the second circular image 1003 is positioned and controlled such that its center coordinates remain the same as the center coordinates of the first circular image 1002. When a pointing input is performed, the second circular image 1003 is positioned such that its center coordinates become the co-ordinates specified by the input. Therefore, a vector from the center coordinates of the first circular image 1002 to the center coordinates of the second circular image 1003 is detected as the movement operation performed by the user. In more detail, in the first input method, the operation input performed to the GUI image 1001 is detected as the movement operation in which the direction of the vector serves as an input direction and a scalar quantity serves as an input quantity.

Accordingly, when an input relating to the operation of moving the operable avatar is performed using the first input method, the operable avatar is controlled so as to move in the virtual space in the input direction (so as to move forward, facing the corresponding direction) at a movement speed corresponding to the input quantity. In other words, the further the user moves the second circular image 1003 away from the center of the first circular image 1002, the more quickly the user can move the operable avatar.

By contrast, the explanatory image 1011 depicts which of the four types of keys is assigned to move the operable avatar forward, backward, leftward, or rightward. Here, each movement direction is defined relatively based on the viewpoint from which the virtual space is drawn. In other words, with the second input method, a forward movement operation is an operation to move the operable avatar in a depth direction (a line-of-sight direction), while a backward movement operation is an operation to move the operable avatar in a front direction. Further, a leftward movement operation is an operation to move the operable avatar in a left direction as seen from the viewpoint, while a rightward movement operation is an operation to move the operable avatar in a right direction as seen from the viewpoint.

When a key input relating to the operation of moving the operable avatar is performed using the second input method, the operable avatar is controlled so as to move in the virtual space in a direction corresponding to the corresponding key (so as to move forward, facing the corresponding direction). Here, since a keyboard generally detects a pressing input as a digital input rather than an analog input, the operable avatar may be controlled so as to maintain the same movement speed.

It should be noted that there is no difference in how the virtual space is drawn or the viewpoint is set, regardless of whether the movement operation is performed using the first input method or the second input method. Since the match-making service according to the present embodiment is configured to accept the movement operation via the GUI image 1001 under the first input method, the GUI image 1001 on the service screen needs to be placed at a fixed position. On the other hand, if an image of an operable avatar is positioned so as to overlap with the GUI image 1001 on the service screen, the user's operability may be impaired. For this reason, the viewpoint is set such that an image 1021 of the operable avatar is disposed at a fixed position in the center of the service screen, as illustrated in FIG. 10A. The virtual space in which the operable avatar is positioned is drawn from this viewpoint. In more detail, the viewpoint from which the virtual space is drawn is set so as to position the operable avatar in the center of a horizontal direction and to keep the legs of the operable avatar of the image 1021 in the vicinity of a lower edge of the service screen, regardless of the position of the operable avatar in the virtual space and whether or not the operable avatar is moving. By contrast, the GUI image 1001 is positioned in the vicinity of an edge of the service screen (in the vicinity of a lower left edge in FIG. 10A) for the convenience of the user using the first input method. In this way, the image 1021 of the operable avatar and the GUI image 1001 are disposed at the same fixed positions on the service screen at all times, regardless of the movement of the operable avatar. Therefore, the distance between these image elements is maintained constant.

The GUI image 1001 needs to be displayed such that the movement operation can be input at any time using the first input method. By contrast, the explanatory image 1011 becomes unnecessary after the user has confirmed which key is used for the desired movement operation. In particular, for the user who mainly performs the movement operation using the first input method, it is not preferable that the visibility of the virtual space on the service screen be reduced by the explanatory image 1011 for the second input method that is not used. For this reason, the explanatory image 1011 on the service screen is only displayed during a time period from when the operable avatar is newly positioned in the virtual space in response to a log in to the service or in response to a request to the transfer of the operable avatar to the battle room to when the movement operation is performed. In other words, until the virtual space is displayed and then the operation of moving the operable avatar is accepted, the explanatory image 1011 continues to be displayed on the service screen. After the movement operation is accepted, the explanatory image 1011 is controlled so as to be hidden as illustrated in FIG. 10B. On the other hand, the GUI image 1001 is continuously displayed on the service screen, regardless of whether or not the operation of moving the operable avatar is performed.

### Information Management

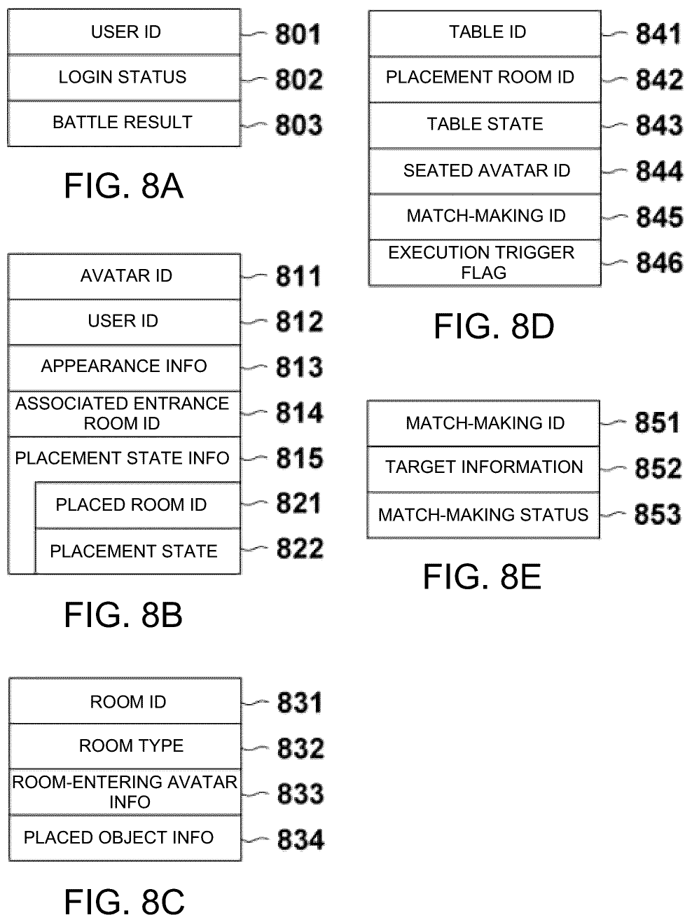

An example of a configuration of various kinds of information managed by the server 200 in relation to the match-making service according to the present embodiment, which is configured as described above, will be described with reference to FIGS. 8A to 8E.

FIG. 8A illustrates an example of a configuration of user information managed for each user. As illustrated in FIG. 8A, the user information managed for each user includes a user ID 801, login status 802, and a battle result 803. The login status 802 and the battle result 803 are managed in association with the user ID 801. The user ID 801 uniquely identifies the user. The login status 802 indicates whether the user is logged in to the service. The battle result 803 indicates the result of the battle game played by the user via the match-making service. When a service login request associated with the user ID 801 is received via the service site or when a service logout request is received, the login status 802 is updated to a corresponding value. Further, when match-making has been established and the executed battle game has ended, the battle result 803 is updated based on the received information regarding the battle result (result information). The result information may be received from the game server of the corresponding outside service or may be input by each user who has participated in the battle game.

FIG. 8B illustrates an example of a configuration of avatar information managed for each avatar. As illustrated in FIG. 8B, the avatar information managed for each avatar includes an avatar ID 811, a user ID 812, appearance information 813, an associated entrance room ID 814, and positioning state information 815. The user ID 812, the appearance information 813, the associated entrance room ID 814, and the positioning state information 815 are managed in association with the avatar ID 811. The avatar ID 811 uniquely identifies the avatar. The user ID 812 uniquely identifies the user associated with the avatar. The appearance information 813 indicates the appearance of the avatar. The associated entrance room ID 814 uniquely identifies the entrance room associated with the avatar. The positioning state information 815 indicates the current positioning state of the avatar in the virtual space. When the avatar is positioned in the entrance room and an appearance change request relating to the appearance customization function is received, the appearance information 813 is updated. The positioning state information 815 includes a positioning room ID 821 and a positioning state 822. The positioning room ID 821 uniquely identifies the room (virtual space) in which the avatar is positioned. The positioning state 822 indicates the state of the avatar in the room. The state of the avatar indicated by the positioning state 822 includes the match-making standby state, the match-making establishing state (or the battle game executing state), and the free state. The positioning state 822 is mainly used to indicate the information regarding the avatar in the battle room. When the avatar is positioned in the battle room and any of various requests relating to the match-making function is received, the positioning state 822 is updated to a corresponding value.

FIG. 8C illustrates an example of a configuration of virtual space information managed for each room. As illustrated in FIG. 8C, the virtual space information managed for each room includes a room ID 831, a room type 832, room-entering avatar information 833, and disposed-object information 834. The room type 832, the room-entering avatar information 833, and the disposed-object information 834 are managed in association with the room ID 831. The room ID 831 uniquely identifies the room. The room type 832 indicates whether the room is the entrance room or the battle room. The room-entering avatar information 833 is information regarding each avatar who has entered the room. The disposed-object information 834 is information regarding each object disposed in the room. The room-entering avatar information 833, which includes information regarding each avatar which has entered the room, includes, for example, the avatar ID of the avatar and information required for drawing the room, such as the position, posture, and appearance of the avatar in the room in which the avatar is positioned. When the avatar is seated in the chair object, the position information and posture information of the avatar may be values uniquely specified for the chair object. When the avatar is positioned in the entrance room, the disposed-object information 834 may include information regarding, for example, decorations disposed in the entrance room. When the user is positioned in the battle room, the disposed-object information 834 may include table information regarding each of the table objects disposed in the room.

The virtual space information is sequentially updated according to the changes of the states of the avatars and table objects positioned in a corresponding room, and is shared each time among the user terminals 100 used by the users whose avatars are positioned in the same virtual space. With the virtual space information, the user terminals 100 can draw the virtual space in which the corresponding operable avatars are positioned.

FIG. 8D illustrates an example of a configuration of table information managed for each table object disposed in the battle room. As illustrated in FIG. 8D, the table information managed for each table object includes a table ID 841, a positioning room ID 842, a table state 843, a seated avatar ID 844, a match-making ID 845, and an execution trigger flag 846. The table state 843, the seated avatar ID 844, the match-making ID 845, and the execution trigger flag 846 are managed in association with the table ID 841 and the positioning room ID 842. The table ID 841 may be an identification number assigned to each table object in the room. The positioning room ID 842 uniquely identifies the room. The table state 843 indicates the use state of the table object. The seated avatar ID 844 uniquely identifies the avatar seated in the chair object associated with the table object. The match-making ID 845 uniquely identifies the match-making process being performed via the table object. The execution trigger flag 846 indicates whether or not the execution of the battle game has been triggered via the table object. A combination of the table ID 841 and the positioning room ID 842 uniquely identifies each of the table objects managed in the match-making service.

The state of the table object indicated by the table state 843 includes the state in which the match-making process is being performed, the state in which the triggered battle game is being executed, and the state in which none of these are performed (the triggered battle game has ended or the match-making process has not started). When the avatar is positioned in the battle room and a match-making request relating to the match-making function is received or the execution of the battle game is triggered or when result information regarding the result of the battle game is received, the table state 843 is updated to a corresponding value. When the avatar is positioned in the battle room and the match-making request based on the operation of selecting the table object is received, the seated avatar ID 844 is updated based on the identification information of the avatar. When, for example, the match-making process for the table object starts, the match-making ID 845 is issued and stored in the table information as information which is referred to for the match-making process. The match-making ID 845 is deleted in response to the completion (establishment or cancellation) of the match-making process or the end of the battle game that has been triggered and executed. The execution trigger flag 846 is, for example, a logical type of information. When the battle game is being executed on the outside service after the establishment of match-making, the execution trigger flag 846 is set to true (True). When the battle game is not being executed, the execution trigger flag 846 is set to false (False).

FIG. 8E illustrates an example of a configuration of match-making information managed for the match-making process being performed for each table object. As illustrated in FIG. 8E, the match-making information relating to the match-making process includes a match-making ID 851, target information 852, and a match-making status 853. The target information 852 and the match-making status 853 are managed in association with the match-making ID 851. The match-making ID 851 uniquely identifies the match-making process. The target information 852 indicates a target to be matched in the match-making process. The match-making status 853 indicates the progress of the match-making process. The target information 852 can be, for example, the user ID of the user who is the target of the match-making, the avatar ID of the user's operable avatar, or both. The target information 852 is updated when a match-making request is received for the table object. The progress indicated by the match-making status 853 includes a match-making standby state, a state in which a request has been made, and a state in which match-making has been established. The match-making status 853 is set to the match-making standby state when the match-making process starts for the table object. After the match-making standby state, the match-making status 853 is further updated according to a match-making request relating to a battle request received for that table object or according to the contents of the response to the battle request.

These pieces of information are generated, managed, and updated by the server control unit 201. Further, these pieces of information can also be stored and managed using an external storage server or the like instead of or in addition to the server storage device 202 and the server memory 203.

### Display Control Process

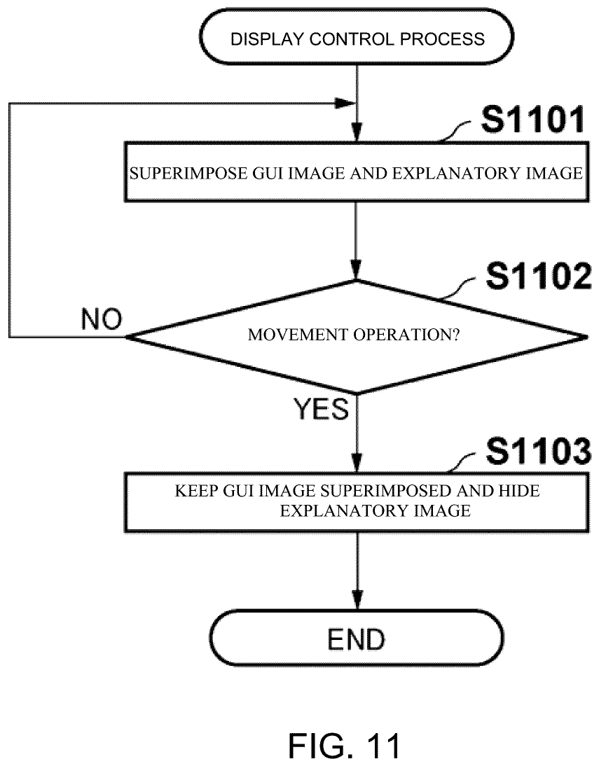

A display control process is performed by the user terminal 100 according to the present embodiment to display the virtual space when the match-making service is used. The following describes the display control process with reference to a flowchart of FIG. 11. The control unit 101 can perform the process corresponding to the flowchart by reading out a corresponding processing program stored in the storage device 102, deploying the processing program in the memory 103, and executing the processing program. This display control process starts when, for example, the user terminal 100 accesses the service site and receives an operation input relating to a service login request or an operation input relating to a movement within the virtual space. In other words, this display control process starts when the operable avatar corresponding to the user is positioned in one of the virtual spaces in response to a request from the user and then an operation of moving the operable avatar is ready to be accepted. Further, in this display control process, unless otherwise specified, the GPU 104 repeatedly performs a process of drawing a three-dimensional space in which at least the user's operable avatar is positioned and a process of generating the service screen based on the virtual space information received from the server 200 during the execution of the process, and the flowchart illustrated in FIG. 11 may omit a description of specific drawing-related processes.

In S1101, the control unit 101 controls the GPU 104 to configure the service screen with a GUI image relating to the first input method and an explanatory image relating to the second input method superimposed thereon.

In S1102, the control unit 101 determines whether or not an operation of moving the operable avatar has been performed after the virtual space is displayed using the service screen. When the control unit 101 determines that the movement operation has been performed after the virtual space is displayed, the process proceeds to S1103. When the control unit 101 determines that the movement operation has not been performed, the process returns to S1101.

In S1103, the control unit 101 controls the GPU 104 to configure the service screen such that the GUI image relating to the first input method is kept superimposed on the service screen while the explanatory image relating to the second input method is not superimposed thereon. Then, the display control ends. That is, after the start of the movement operation, the explanatory image relating to the second input method is controlled so as to be hidden on the service screen through the process in S1103.

As described above, the match-making system according to the present embodiment can improve the operability during the use of the virtual space.

### Second Embodiment

In the embodiment described above, match-making is performed for the battle game of the single game title in the match-making service. However, embodiments of the present invention are not limited thereto, and there may be a plurality of game titles for which match-making can be performed using the match-making system.

In such an embodiment, a battle room is set up for each game title so that the user can be easily matched with an opponent for the game title that the user wants to play. That is, one battle room is associated with one of the game titles, and a match-making process performed via the battle room matches users who want to play the game title. For example, the room type 832 included in the virtual space information relating to a battle room may include information regarding a game title associated with the battle room. With this configuration, which of the game titles is associated with the battle room can be recognized by referring to the room type 832.

Accordingly, the user selects a game title to play (a game title for which the user wants to be matched with an opponent) in order to transfer the user's operable avatar from the entrance room to the battle room. That is, which battle room of the game content a movement request has been made for is determined based on, for example, the user's selection made while the operable avatar is positioned in the entrance room. The information regarding the selected game title is transmitted to the server 200 together with the transfer request. Based on the information, the server control unit 201 controls the operable avatar such that the operable avatar is positioned in the battle room associated with the game title.

### First Modification

In the embodiments described above, each battle room primarily provides the match-making function, which matches users, and the spectator function. However, embodiments of the present invention are not limited thereto. Each battle room may, for example, provide a function for selling/purchasing a relevant item relating to the game content for which match-making is performed. For example, when the battle game for which the match-making function is provided is a TCG, the sale/purchase function may be provided to sell or purchase real items (game cards) that can be used in the TCG. As the sale/purchase function, a payment procedure may be performed in the match-making service. Alternatively, the sale/purchase function may be provided indirectly. For example, the user terminal 100 may be transferred to a sales page of a target product on an e-commerce (EC) website.

Further, the relevant items do not need to be real items. Instead, the relevant items may include, for example, in-game items or downloadable content.

For example, the sale/purchase function may be usable in an area (second area) different from an area (first area) in a battle room. The first area refers to an area in which the match-making function is provided in the battle room, that is, an area in which a table object is disposed. In such an embodiment, for example, the match-making function is configured to be made available to the user on the condition that the operable avatar is positioned in the first area, while the sale/purchase function is configured to be made available to the user on the condition that the operable avatar is positioned in the second area. That is, the server control unit 201 accepts a match-making request from the user terminal 100 and performs the match-making process on the condition that the operable avatar of the user of the user terminal 100 is positioned in the first area, while the server control unit 201 accepts a purchase request for a relevant item from the user terminal 100 and performs a sale-related process on the condition that the operable avatar of the user of the user terminal 100 is positioned in the second area.

### Second Modification

In the embodiments described above, the two types of input methods are available as the operation of moving the operable avatar: the first input method for accepting a movement operation in response to a pointing input to the GUI image; and a second input method for accepting a movement operation in response to an operation input to a specific key of the keyboard. However, the embodiments of the present invention are not limited thereto. For example, the second input method may be a method for accepting a movement operation in response to an operation input to a physical operation member other than the keyboard.

### Third Modification

In the embodiments described above, an operation input relating to the use of the match-making function is acceptable via a table object disposed in a battle room. However, the embodiments of the present invention are not limited thereto. For example, positioning an operable avatar at a specific position in the battle room may enable an operation input relating to the use of the match-making function without using any object.

### Fourth Modification

In the embodiments described above, the battle game of the outside service for which match-making is provided in the match-making service has been described as a TCG. However, the embodiments of the present invention are not limited thereto. The battle game for which match-making is provided may be a battle game of another genre. Further, the game for which match-making is provided is not limited to a battle game. As long as a plurality of users can participate in the game, the game for which match-making is provided may be, for example, a game involving cooperative play.

Further, the game in which match-making is provided does not need to be a game which is performed using the outside service but may be a game provided as a function of the match-making service. That is, the match-making service may include a function of executing an online game in which users matched with each other by the match-making process participate. In such an embodiment, the server control unit 201 further performs a process corresponding to a game function provided by the match-making service to control the trigger of the execution of a battle game after the establishment of match-making. Accordingly, when the game provided by the game function is a TCG, the server control unit 201 controls information to be transmitted to each user terminal 100 such that the display 110 of the user terminal 100 used by one of the users participating in the TCG displays, instead of the service screen, an image captured by the imaging unit 120 of the user terminal 100 used by the other user (opponent).

### Fifth Modification

In the embodiments described above, the control unit 101 performs the display control process. Alternatively, in order to realize the function corresponding to the display control process, the server control unit 201 may generate a corresponding display control instruction and transmit the display control instruction to the user terminal 100 so that the control unit 101 performs a similar process to the display control process. In this case, the user terminal 100 may obtain a determination result of part of the processes required during the display control process and transmit the determination result to the server 200 and the server control unit 201 may use the determination result to generate a display control instruction based on the received information.

### Sixth Modification

In the embodiments described above, the match-making service is provided from the server 200 to the user terminal 100 which has logged in to the service via the browser. Alternatively, the match-making service may be provided via a dedicated application installed on the user terminal 100. In this case, in order to provide the match-making service, the dedicated application may connect to an external apparatus including the server 200, transmit a processing request for part of the functions to the external apparatus, and acquire a processing result to control the display or the like relating to the dedicated application.

### Seventh Modification

In the embodiments and modifications described above, the virtual space provided in the match-making service is a three-dimensional space in which three-dimensional models are arranged. However, the embodiments of the present invention are not limited thereto. For example, the present invention can also be applied to, for example, a two-dimensional space in which two-dimensional models are arranged.

### Summary of Embodiments

The embodiments described above disclose at least the following storage medium, information processing apparatus, server, and display system.

(1) A non-transitory computer-readable storage medium storing therein a program that causes a computer to perform:
a display control process of displaying a virtual space in which a virtual character associated with a user is positioned;
an input process of accepting a movement operation for moving the virtual character; and
a control process of controlling a movement of the virtual character in response to the movement operation,
in which the input process includes a first input method and a second input method as methods for inputting the movement operation, and
the display control process includes performing control so as to:
   continuously display, together with the virtual space, a first image relating to the first input method regardless of whether or not the virtual character has moved; and
   continuously display, after displaying the virtual space, a second image relating to the second input method until the movement operation is accepted, and hide the second image after the movement operation is accepted.

(2) The non-transitory computer-readable storage medium according to (1),
in which the first image includes a graphical user interface (GUI) image,
the first input method is an input method for accepting the movement operation through an operation input to the displayed GUI image, and
the second input method is an input method for accepting the movement operation through an operation input to a keyboard.

(3) The non-transitory computer-readable storage medium according to (2), in which the display control process includes performing control such that a distance between the virtual character and the first image is maintained constant in an area where an image of the virtual space is displayed.

(4) The non-transitory computer-readable storage medium according to (2) or (3), in which the display control process includes displaying the virtual character and the first image without overlapping with each other while the virtual character is moving.

(5) The non-transitory computer-readable storage medium according to any one of (2) to (4), in which the display control process includes disposing and displaying the first image in a vicinity of an edge of an area in which an image of the virtual space is displayed.

(6) The non-transitory computer-readable storage medium according to any one of (2) to (5),
in which the virtual character includes a head, a torso, and a leg, and
the display control process includes placing and displaying the leg of the virtual character in a vicinity of a lower edge of an area in which an image of the virtual space is displayed, regardless of whether or not the virtual character is moving.

(7) The non-transitory computer-readable storage medium according to any one of (2) to (6),
in which the GUI image includes a first circular image and a second circular image, and
the display control process includes displaying the first circular image at a fixed position and movably displaying the second circular image within an area of the first circular image.

(8) The non-transitory computer-readable storage medium according to (7), in which the second circular image is moved in response to the operation input to the GUI image.

(9) The non-transitory computer-readable storage medium according to any one of (1) to (8), in which the control process includes changing a movement speed of the virtual character according to the movement operation using the first input method.

(10) The non-transitory computer-readable storage medium according to any one of (1) to (9), in which the control process includes changing an orientation of the virtual character based on the movement operation.

(11) The non-transitory computer-readable storage medium according to any one of (1) to (10),
in which the display control process includes disposing and displaying a first object and a second object in the virtual space, and
the control process includes controlling the movement of the virtual character such that the virtual character is unable to enter an area in which the first object is disposed and such that the virtual character is able to enter an area in which the second object is disposed.

(12) The non-transitory computer-readable storage medium according to any one of (1) to (11),
in which the virtual space includes a first area in which the user is able to be matched with another user who is to be an opponent of a game, and
the program further causes the computer to perform a process of, on a condition that the virtual character associated with the user has been positioned in the first area in response to the movement operation, matching the user with the another user.

(13) The non-transitory computer-readable storage medium according to any one of (1) to (12),
in which the virtual space includes a second area in which an item usable in a game is sold, and
the program further causes the computer to perform a process of, on a condition that the virtual character associated with the user has been positioned in the second area in response to the movement operation, accepting a request from the user to purchase the item.

(14) An information processing apparatus including:
display control means which causes display means to display a virtual space in which a virtual character associated with a user is positioned;
input means which accepts a movement operation for moving the virtual character; and
control means which controls a movement of the virtual character in response to the movement operation,
in which the input means includes a first input method and a second input method as methods for inputting the movement operation, and
the display control means controls display of the display means such that:
   the display means continuously displays, together with the virtual space, a first image relating to the first input method regardless of whether or not the virtual character has moved; and
   the display means continuously displays, after displaying the virtual space, a second image relating to the second input method until the movement operation is accepted, and hides the second image after the movement operation is accepted.

(15) A server including:
display control means which causes an information processing apparatus to display a virtual space in which a virtual character associated with a user is positioned;
input means which accepts a movement operation for moving the virtual character; and
control means which controls a movement of the virtual character in response to the movement operation,
in which the input means includes a first input method and a second input method as methods for inputting the movement operation, and
the display control means controls display of the information processing apparatus such that:
   the information processing apparatus continuously displays, together with the virtual space, a first image relating to the first input method regardless of whether or not the virtual character has moved; and
   the information processing apparatus continuously displays, after displaying the virtual space, a second image relating to the second input method until the movement operation is accepted, and hides the second image after the movement operation is accepted.

(16) A display system including:
display control means which causes display means of an information processing apparatus to display a virtual space in which a virtual character associated with a user is positioned;
input means which accepts a movement operation for moving the virtual character; and
control means which controls a movement of the virtual character in response to the movement operation,
in which the input means includes a first input method and a second input method as methods for inputting the movement operation, and
the display control means controls display of the display means such that:
   the display means continuously displays, together with the virtual space, a first image relating to the first input method regardless of whether or not the virtual character has moved; and
   the display means continuously displays, after displaying the virtual space, a second image relating to the second input method until the movement operation is accepted, and hides the second image after the movement operation is accepted.

### Other Embodiments

The present invention is not limited to the embodiments described above, and various modifications and changes can be made within the scope of the present invention.

What is claimed is:

1. A non-transitory computer-readable storage medium storing therein a program that causes a computer to perform:
a display control process of displaying a virtual space in which a virtual character associated with a user is positioned;
an input process of accepting a movement operation for moving the virtual character; and
a control process of controlling a movement of the virtual character in response to the movement operation,
wherein the input process includes a first input method and a second input method as methods for inputting the movement operation, and
the display control process includes performing control so as to:
continuously display, together with the virtual space, a first image relating to the first input method regardless of whether or not the virtual character has moved; and
continuously display, after displaying the virtual space, a second image relating to the second input method until the movement operation is accepted, and hide the second image after the movement operation is accepted.

2. The non-transitory computer-readable storage medium according to claim 1,
wherein the first image includes a graphical user interface (GUI) image,
the first input method is an input method for accepting the movement operation through an operation input to the displayed GUI image, and
the second input method is an input method for accepting the movement operation through an operation input to a keyboard.

3. The non-transitory computer-readable storage medium according to claim 2, wherein the display control process includes performing control such that a distance between the virtual character and the first image is maintained constant in an area where an image of the virtual space is displayed.

4. The non-transitory computer-readable storage medium according to claim 2, wherein the display control process includes displaying the virtual character and the first image without overlapping with each other while the virtual character is moving.

5. The non-transitory computer-readable storage medium according to claim 2, wherein the display control process includes disposing and displaying the first image in a vicinity of an edge of an area in which an image of the virtual space is displayed.

6. The non-transitory computer-readable storage medium according to claim 2,
wherein the virtual character includes a head, a torso, and a leg, and
the display control process includes placing and displaying the leg of the virtual character in a vicinity of a lower edge of an area in which an image of the virtual space is displayed, regardless of whether or not the virtual character is moving.

7. The non-transitory computer-readable storage medium according to claim 2,
wherein the GUI image includes a first circular image and a second circular image, and
the display control process includes displaying the first circular image at a fixed position and movably displaying the second circular image within an area of the first circular image.

8. The non-transitory computer-readable storage medium according to claim 7, wherein the second circular image is moved in response to the operation input to the GUI image.

9. The non-transitory computer-readable storage medium according to claim 1, wherein the control process includes changing a movement speed of the virtual character according to the movement operation using the first input method.

10. The non-transitory computer-readable storage medium according to claim 1, wherein the control process includes changing an orientation of the virtual character based on the movement operation.

11. The non-transitory computer-readable storage medium according to claim 1,
wherein the display control process includes disposing and displaying a first object and a second object in the virtual space, and
the control process includes controlling the movement of the virtual character such that the virtual character is unable to enter an area in which the first object is disposed and such that the virtual character is able to enter an area in which the second object is disposed.

12. The non-transitory computer-readable storage medium according to claim 1,
wherein the virtual space includes a first area in which the user is able to be matched with another user who is to be an opponent of a game, and
the program further causes the computer to perform a process of, on a condition that the virtual character associated with the user has been positioned in the first area in response to the movement operation, matching the user with the another user.

13. The non-transitory computer-readable storage medium according to claim 1,
wherein the virtual space includes a second area in which an item usable in a game is sold, and
the program further causes the computer to perform a process of, on a condition that the virtual character associated with the user has been positioned in the second area in response to the movement operation, accepting a request from the user to purchase the item.

14. An information processing apparatus comprising:
display control means which causes display means to display a virtual space in which a virtual character associated with a user is positioned;
input means which accepts a movement operation for moving the virtual character; and
control means which controls a movement of the virtual character in response to the movement operation,
wherein the input means includes a first input method and a second input method as methods for inputting the movement operation, and
the display control means controls display of the display means such that:
the display means continuously displays, together with the virtual space, a first image relating to the first input method regardless of whether or not the virtual character has moved; and
the display means continuously displays, after displaying the virtual space, a second image relating to the second input method until the movement operation is accepted, and hides the second image after the movement operation is accepted.

15. A server comprising:
display control means which causes an information processing apparatus to display a virtual space in which a virtual character associated with a user is positioned;
input means which accepts a movement operation for moving the virtual character; and
control means which controls a movement of the virtual character in response to the movement operation,
wherein the input means includes a first input method and a second input method as methods for inputting the movement operation, and
the display control means controls display of the information processing apparatus such that:
the information processing apparatus continuously displays, together with the virtual space, a first image relating to the first input method regardless of whether or not the virtual character has moved; and
the information processing apparatus continuously displays, after displaying the virtual space, a second image relating to the second input method until the movement operation is accepted, and hides the second image after the movement operation is accepted.

16. A display system comprising:
display control means which causes display means of an information processing apparatus to display a virtual space in which a virtual character associated with a user is positioned;
input means which accepts a movement operation for moving the virtual character; and
control means which controls a movement of the virtual character in response to the movement operation,
wherein the input means includes a first input method and a second input method as methods for inputting the movement operation, and
the display control means controls display of the display means such that:
the display means continuously displays, together with the virtual space, a first image relating to the first input method regardless of whether or not the virtual character has moved; and
the display means continuously displays, after displaying the virtual space, a second image relating to the second input method until the movement operation is accepted, and hides the second image after the movement operation is accepted.
